(19) United States
(12) Patent Application Publication
(10) Pub. No.: US 2020/0314986 A1
(43) Pub. Date: Oct. 1, 2020

(54) LIGHTING CONTROL

(71) Applicant: SIGNIFY HOLDING B.V., EINDHOVEN (NL)

(72) Inventor: VINCENT ANTOINE JOSEPHUS LUIJCKS, SON (NL)

(21) Appl. No.: 16/310,841

(22) PCT Filed: Jun. 20, 2017
(86) PCT No.: PCT/EP2017/064990

§ 371 Date: Dec. 18, 2018

(30) Foreign Application Priority Data
Jun. 30, 2016 (EP) 16177291.8

(51) Int. Cl. H05B 47/14; H05B 47/19

(52) U.S. Cl. CPC H05B 47/14; H05B 47/19

(57) ABSTRACT

A lighting device and associated control method, the device including at least one light source for providing illumination and at least a first and second module, said first and second modules being electrically powered, and independently controllable between a power on state and a power off state. Profile data for the device is stored, each profile defining a power state for said at least first and second modules, and the power state of said first and second modules is controlled to correspond to a selected profile stored in the memory. The selected profile may be chosen based on a trigger event such as an output from a sensor on the device, or a received control signal.

### TECHNICAL FIELD

The present disclosure relates to control of power in a lighting device and a lighting system, and particularly, but not exclusively to low power states such as standby states for such devices and systems.

### BACKGROUND

Lights and lighting systems for providing illumination are becoming increasingly sophisticated, and multiple lighting devices or luminaires can be connected together in so called “connected lighting” systems and controlled individually or in a group or groups to provide illumination of a space such as a room. In such systems, each luminaire typically includes control electronics, for example for communication with a system controller or other luminaires, and such electronics consume power, even when the light is off, as communication needs to be maintained if the luminaire is disconnected from a power supply completely, no communication is possible and the luminaire is not system ready.

EP 2717655 A1 discloses a lighting control system wherein, once a user-operable switch has been actuated, a light has been turned on and a first occupancy signal has been received, the wireless receiver is activated, yet only periodically, when a transmission of the occupancy signal is expected. This uses less power than a wireless receiver that is constantly powered.

US 2011/0074225 A1 discloses switching off a motion sensor temporarily during the period that a delay in switching off the lights, due to lack of detected motion, is active thereby saving energy.

### SUMMARY

It is desirable to be able to provide a lighting device or a system of devices having reduced power consumption, particularly in a standby mode. It is further desirable to have finer granularity of control over the power consumption of devices in different states.

According to a first aspect of the invention, there is provided a lighting device comprising at least one light source for providing illumination; at least a first and second module, said first and second modules being electrically powered, and independently controllable between a power on state and a power off state; a memory for storing profile data, each profile defining a power state for said at least first and second modules; a controller adapted to control the power state of said first and second modules to correspond to a profile stored in said memory.

In this way a plurality of different power states are possible for a single lighting device, and depending on the power state different functionalities are possible. Conversely, for a given required functionality (which functionality may vary over time) a power state can be adopted which minimises power consumption.

In embodiments the first module is a communication module adapted to receive control signals for controlling said device, and optionally the second module is a sensor. Multiple different combinations of modules are possible however, and embodiments may include more than one sensor and may not include any sensors for example. Other examples of possible modules include a lighting control interface (such as a DALI interface), a speaker, or a heating/cooling/ventilation component for example, however any power consuming component which might be integrated into or powered by a lighting device can be considered.

It should be noted that the light source(s) and/or any driver(s) for such light sources can also be independently controlled between power states, and power profile data can include information for setting the power state of the light source(s) and drive(s) which can be controlled by the controller.

A sensor can be any type of sensor, such as a motion sensor (eg PIR sensor), a light sensor, a temperature sensor, a humidity sensor, a gas sensor, an audio sensor or image sensor. Multiple different types of sensor can be included in a single device, and/or a single device may include multiple sensors of the same type

The controller is adapted to change the power state of said first and/or second module in response to one or more trigger events, according to some embodiments. In this way, a trigger event can be detected and, based on the profile data stored in said memory, an appropriate stored profile can be determined, and the power state of each of the modules set to the defined state for that profile.

In embodiments, a trigger event is an output from one or more sensors of the device. Thus in an embodiment where a sensor is powered and operational, a detected event (such as motion of a person or animal within a sensed range, or a detected level of CO₂ above a certain threshold) can cause that device to enter a different power state. Typically this will be to power up further modules and/or the light source to provide illumination, and may also result in the device sending a control signal to another device or a controller of a system to which the device belongs, and which may include other similar lighting devices.

In embodiments a trigger event is a received control signal. The control signal may be received from a controller (of a lighting system such as a BMS controller for example) or from another lighting device, optionally via a controller). The control signal may indicate a change of power profile of another device, a change of state such a lighting state of another device, or an output of a sensor of another device for example.

A control signal may specify a power profile to be adopted, or a lighting device, or a system controller may determine an appropriate, or the most appropriate power profile based on the requirements of the device, which may typically be changed by a trigger event. Stated differently, a device or a system controller may derive an appropriate power profile based on a received control signal, and also optionally on the previous state of a device.

In an embodiment, a power profile, from among the possible stored profiles, is selected based on the required functionality of a device, in response to a trigger event. The required functionality may depend, amongst other things on the position of the device within a system or installation, the previous state or functionality of the device, the status and function of other devices in a system, and the overall rules or logic governing a system of which the device is a part. Based on the required functionality is determined which modules are required to operate, and the power profile which consumes the least power, but which retains power to the required modules is selected.

According to a further aspect of the invention, there is provided a method of controlling a lighting device comprising at least one light source for providing illumination; and at least a first and second module, said first and second modules being electrically powered, and independently controllable between a power on state and a power off state, the method comprising storing profile data, each profile defining a power state for said at least first and second modules detecting one or more trigger events; selecting a profile from among the stored profiles in response to the one or more detected trigger events; and controlling the power state of said first and second modules to correspond to said selected profile.

In embodiments, at least one of said first and second modules is a sensor, and a trigger event is an output from one or more sensors of the device. In further embodiments, at least one of said first and second modules is a communications module, and a trigger event is a received control signal.

A yet further aspect of the invention provides a method of controlling a lighting system comprising a plurality of lighting device, each said device comprising at least one light source for providing illumination; and at least a first and second module, said first and second modules being electrically powered, and independently controllable between a power on state and a power off state, the method comprising storing profile data in each lighting device, each profile defining a power state for said at least first and second modules; detecting one or more trigger events; selecting a profile for at least one lighting device from among the stored profiles in response to the one or more detected trigger events; and controlling the power state of said first and second modules of the at least one lighting device to correspond to said selected profile.

In embodiments, selecting a profile for a first device and controlling the power state of that first device is performed base on the output of a second device. Thus the output of one lighting device, may act as a trigger event for a second lighting device. The output from the first device may indicate or be responsive to a sensor output, a change of lighting output, or a change of power profile for example.

Different power profile data may be stored in different lighting devices of the system in embodiments, and the power profile or profiles stored may depend on the position of the lighting device in the system.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings, in which:

FIG. 1 is a schematic representation of a lighting device;

FIG. 2 shows profile data in tabular form;

FIG. 3 is a floorplan illustrating a lighting system installed in a space;

FIG. 4 shows an individual entering the space of FIG. 3;

FIG. 5 shows a development of the space of FIG. 4;

FIG. 6 is a system diagram showing communication between system components;

FIG. 7 is a flow chart illustrating control of a lighting device.

### DETAILED DESCRIPTION OF EMBODIMENTS

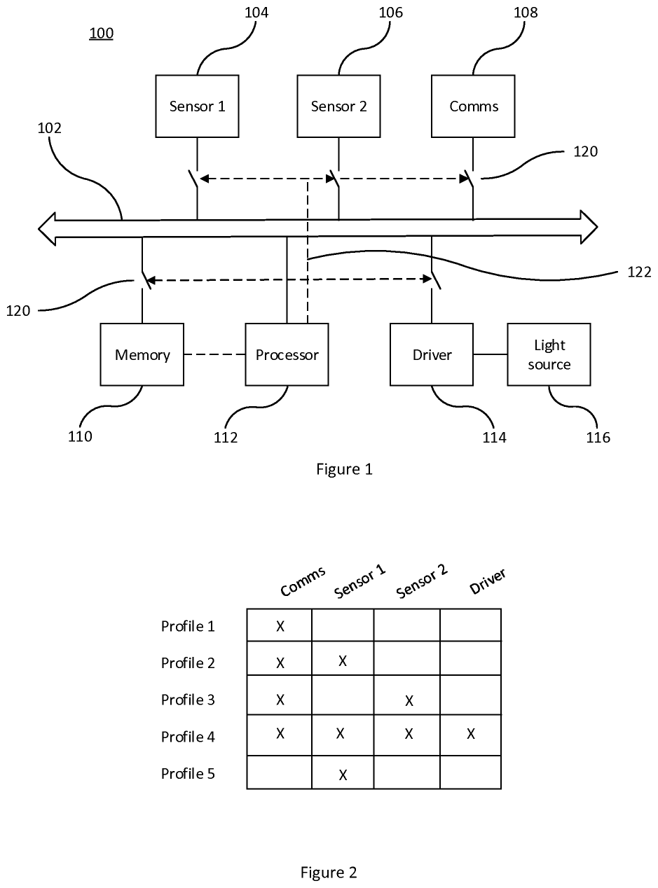

Referring to FIG. 1, there is shown schematically a luminaire or lighting device 100 including a driver 114 connected to a power bus 102, and a light source 116 driven by the driver. The light source may be an LED for example, or a group of LEDs which can be individually controllable. More than one light source may be provided per lighting device, optionally driven by more than one driver. Other light sources such as lamps are possible.

The power bus is typically connected to a mains supply, and power other modules or units in the lighting device, including first and second sensors 104 and 106, a communication module 108, a memory 110 and a processor 112. In this example, all units or modules powered by the bus 102, with the exception of processor 112 can be individually connected and disconnected to the bus by switches 120 (only two of which are labelled in FIG. 12 for clarity). Thus each of modules 104, 106, 108, 110 and 114 can be powered up or powered down independently, under the control of processor 112 via control signals indicated by dashed line 122.

First and second sensors are shown, but more than two sensors, or one or no sensors can be provided in examples. Possible types of sensor include motion sensors (such as PIR sensors), light sensors for detecting ambient light levels, temperature sensors, humidity sensors, gas sensors such as CO₂ sensors, particle measurement sensors, audio sensors and imaging sensors such as cameras. Different combinations of multiple sensor types are possible, depending on the application or situation, however in this example, sensor 1 is a motion sensor and sensor 2 is an image sensor.

Communications module 108 allows the device to communicate with other devices and/or a central controller such as a lighting controller and/or Building Management System (BMS) typically wirelessly, although wired communication is possible. In the case of wireless communication, the module preferably includes a wireless transceiver and provides communication over radio frequency, using a protocol such as Wi-Fi, Bluetooth or Zigbee for example.

Memory 110 is preferably non-volatile memory such as an EPROM or flash memory, and can be used to store power profiles which will be explained in greater detail below. Data in memory 110 can be accessed by processor 112 as indicated by a dashed line in FIG. 1. In some cases, the memory and processor may be integrated in a single unit or chip.

Switches 120 are typically transistors, such as bipolar transistors, capable of controlling power switching suitable for the respective modules or units they supply. Switches 120 need not physically isolate modules to be powered down, but substantially prevent such modules from consuming power from the bus 102.

It will be understood that by arranging for each or multiple modules to be individually and independently controllable with respect to their power state, that multiple different power profiles are possible for a single device, according to the setting of the switches 120 for each module.

FIG. 2 shows a table illustrating four different power profiles for the device of FIG. 1. A module is shown as having its switch set to an on state (ie powered on) by an “x” in the respective cell in the table. Profile 1 is a deep sleep standby state in which both sensor 104 and 106, and driver 114 are powered down (which in this example corresponds to disconnection to the electrical supply to ensure substantially zero power consumption by these modules). In this example the memory is assumed to be integrated into the processor and therefore only the processor (and memory) and communications module are powered on in profile 1.

This profile results in the lowest possible power consumption for the device, while still being contactable by other devices or a central controller. Power consumption in such a state may be less than or equal to 0.5 W and may be less than or equal to 0.3 W.

In profile 2, sensor 1 which is a motion sensor is additionally powered, compared to profile 1. Power consumption is higher than profile 1, but since sensor 2 and the driver are still powered down, profile 2 is still considered a low power state. When in profile 2, a device can sense a person approaching for example and this sensed information can be used to change the profile of the device, and/or other devices.

In profile 3, sensor 1 is powered down, but sensor 2 is in an active power state. In this example, sensor 2 is a camera integrated into the device. Thus in profile 3 image recording can be performed, but the driver and sensor 1 are powered down to ensure power consumption is kept to a minimum.

In profile 4, all modules of the device are powered on, allowing both sensors to function, and the light source or sources to operate.

Profile 5 illustrates an alternative deep sleep state, in which the communications module is powered down, but sensor 1 remains powered an active. This may be useful in certain system applications as will be described below.

Data representing power profiles can be stored in memory 110 of each device. Not all profiles need to be stored in each device, for example if it is determined that in an application a particular device or devices are only required to operate in profiles 1 and 4, then only these profiles need be stored. Different devices may include different combinations of modules, and therefore further different profiles may be set or stored, and the profiles stored in each device may be selected as necessary.

Even if a profile is not required by a device in an implementation, it may still be stored, for uniformity of programming for example. Furthermore, profiles may be stored which are not relevant, e.g. because a module to which that profile relates is not present. Such profiles may still be employed e.g. by ignoring parts of the profile which are not relevant. In the example of FIG. 2 then, if profile 4 is set for a device which does not include sensor 2 (a camera), then the communication module, sensor 1 and the driver are powered on, and the data to power on sensor 2 is ignored as not relevant.

A profile or profiles may also be specified without reference to specific modules—e.g. a “fully on” profile may specify that all modules are to be powered, whatever, and however many those modules may be. A “deep sleep” profile may specify that only the communication module and the processor (and memory) are to be powered, and all other modules are to be powered down, whatever other modules are present.

Power profiles may be programmed and reprogrammed or updated as required in certain embodiments. For example, a plurality of physically identical devices can be installed in a space, and at the time of installation, or shortly before or after, different power profiles can be programmed into different devices, according to their position in the space and/or the function they are to perform. Power profiles may be programmed remotely, using the communication module for example.

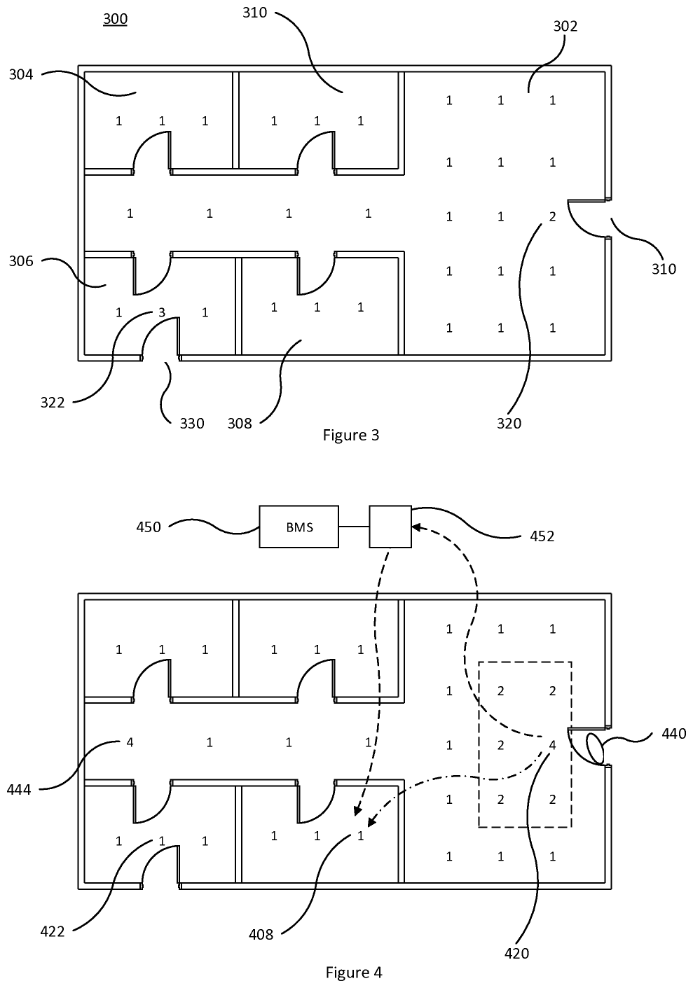

FIG. 3 is an example floorplan showing a number of lighting devices in a lighting system. Each number shown in the figure represents a lighting device installed in the ceiling, and the value of the number represents the current power profile which that device is set to. In this example, the profiles correspond to the profiles of FIG. 2. Further devices and different types of devices could be included such as wall lights or floor lighting, but only ceiling lights or luminaires are shown for simplicity.

As shown in FIG. 3, a lighting system may be employed in an office space comprising an open plan office area 302 leading onto a corridor, and accessed from the corridor are four separate offices 304, 306, 308 and 310. A doorway 310 leads into the open plan area, and a further doorway 330 represents a fire exit leading from office 306.

FIG. 3 illustrates the default lighting configuration for the system, when the office space is not being used, for example at night. The majority of the lighting devices are set to profile 1, which is a deep sleep state which has low power consumption. As noted, in this state the devices are contactable via a communications module, but the driver or drivers, and any sensors are powered down.

One exception is device 320, which is located adjacent to the door 310. This device is programmed or controlled to return to profile 2 as a default state, and profile 1 need not be stored in this device. Accordingly the motion sensor of device 320 is active. Also, device 322 is set to profile 3, which allows a camera incorporated in the device to remain active, and the camera may be used for example to monitor fire escape 330. It should be noted that not all devices in the system need have cameras (or motion sensors), and those without cameras may not have profile 3 stored, or can simply ignore it as a null setting.

FIG. 4 illustrates the office space of FIG. 3, as an individual 440 enters the office space via door 310 (FIG. 3). Device 420, being previously set in profile 2 is able to detect movement of the door and/or individual, and in response changes to profile 4, activating the driver to allow the light source to be switched on.

Considering the function of device 320, it is noted that it could also be set to profile 5 as a deep sleep state, in which the communications module is not powered, thus further reducing power consumption. In this profile it cannot be instructed or contacted remotely, however it can still detect entry at the doorway 310, and this trigger can activate the communication module to allow the device to send information indicating the sensed entry.

Detection or sensing of the event of an individual entering the office space also causes other devices to change state. This may be via communication from device 420 to a Building Management System (BMS), via a receiver 452 for example, as indicated by a dashed arrow in FIG. 4. The BMS can then in turn issue control signals to other lighting devices in the system to change power profile as shown by a further dashed arrow. The BMS may also wish to control systems other than the lighting system in response, eg a heating or ventilation system.

Alternatively, device 420 may communicate directly with other devices such as device 408, as shown by a dot dash arrow in FIG. 4, to change its power profile. A combination of communication methods may be used to cause other devices to change state. For example nearby devices can be updated directly, and devices located further away can be updated via a central controller or BMS. In embodiments, lighting devices may act as relays, even if their state is not to be changed, to pass on a control message to change the profile of another device.

In the example of FIG. 4, the trigger event of the detection or sensing of an individual entering door 440 by device 420 causes changes to the profile settings of the devices immediately surrounding device 420, indicated in the figure by a dashed box. These devices are switched from profile 1 to profile 2 to power the motion sensor in each device. Such an event triggered change allows lights in the path of the user to be sequentially activated to increasing power states.

The trigger event also switches the profile of a device 444 located at the end of the corridor to profile 4, allowing the light source and both sensors to be turned on. This for example allows the end of the corridor to be lit, so that it can be seen by a user entering the open plan section, and to start recording images of the corridor.

Finally the profile of device 422 is switched from 3 to 1, to reduce power consumption. This may be because it is determined in this installation that if somebody is present in the office the fire escape does not need to be closely monitored.

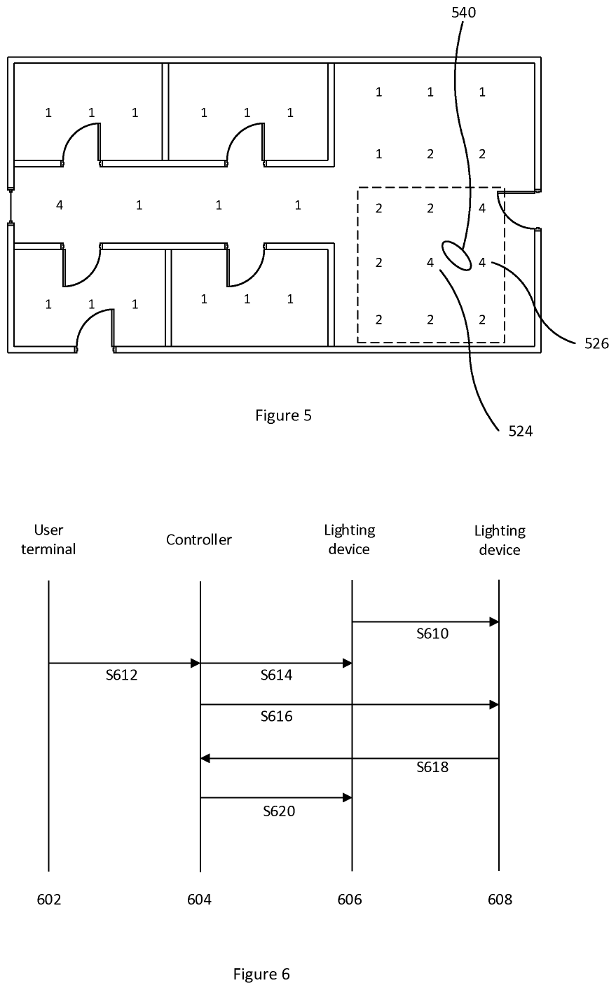

FIG. 5 illustrates the same office environment as FIG. 3 and FIG. 4, as the individual 540 moves further into the office from the doorway. It can be seen that the individual has moved sufficiently near devices 524 and 526 to be detected by the motion sensors of these devices (it is recalled that these devices were previously set to power profile 2 to allow their motion sensors to be powered and in operation). This triggers devices 524 and 526 to switch to power profile 4, to power their light sources (and sensor 2 if present).

At the same time the detection of motion by the sensor of devices 524 and 526 causes the adjacent devices (indicated by a dashed box) to be switched to profile 2 if they were previously in profile 1. Adjacent devices which were previous in profile 4 are left unchanged. In this way the area where an individual is, or has been present is illuminated, and adjacent areas where that user may move to next have motion sensors activated so that they can be switched to provide illumination as necessary.

As has been described, trigger events can cause devices to change power profile. Trigger events may be sensed events from sensors on one or more devices of the system, but other trigger events can give rise to power profile changes also.

For example each device may include a timer, or a timer may equivalently be provided for each device at a central controller or BMS. The time spent in one or more profiles can be monitored, (ie a timer can be reset when a device enters a profile) and when the duration reaches or exceeds a predetermined value, the profile of the device is changed. Using such a timer allows the device to be reverted to a lower profile after a period of inactivity, either directly, or by cycling through other profiles. In the example of FIGS. 3 to 5, devices in the open plan office section 302 can be controlled to switch from profile 4 to profile 2 if no motion is detected by the motion sensor of that device for a period of, say, 10 minutes. Devices can further be controlled to switch from profile 2 to profile 1 (or the lowest default profile of that device) if no motion is detected by the sensor of that device or any adjacent device for a period of 10 minutes.

Particular devices may be controlled to revert to different profiles after periods of inactivity. For example, device 322 can be controlled to revert from profile 4 to profile 3 after a duration, but not to revert to profile 1 ever.

A further trigger can be a clock setting, (ie the time of day), either controlled centrally or by a clock in the device itself A device can for example be controlled to always revert to a certain power profile at a fixed time or times. In the above examples, the devices of the system may be configured to switch to the profiles shown in FIG. 3 at 10 pm every weekday.

In the above description, control of the lighting device or devices, and triggers have been largely automated, in typically in response to environmental or external stimuli such as detected motion or time of day. It should also be noted that a trigger may be a lighting command from a user or from a lighting controller. For example a user may turn a lighting device, or a block or group of devices on from a wall panel or a mobile user terminal, or a user may recall a pre-determined scene setting, in which the lighting states of one or more devices are pre-set. A user may also choose to manually turn off a light or lights. Such a trigger results in the affected devices changing to a corresponding power profile in which the light source(s) and associated driver are powered on or off respectively, if they are not already in this profile. If multiple profiles are available which allow a device to have the light source(s) powered, the lowest power of these profiles may automatically be selected, if no other profile is pre-specified. Therefore it can be seen that a device may receive an instruction or control signal which includes a specific power profile which is to be adopted, but may also determine an appropriate power profile to be adopted, based on a control signal which does not specify any particular power profile (eg to turn a light source on or off, or to activate or deactivate a sensor). In this case the device determines an appropriate profile based on the function required of the device in a particular state. The profile determined may be based on a rule or set of rules, such as a rule to minimise power consumption, and/or a rule that a device should always be contactable from a central controller.

Triggers may be used in combinations, using logic rules, so that different situations can be accommodated accordingly, and devices can transition between states. The lighting device may be programmed or configured such that for a predetermined trigger the lighting device is controlled to switch the lighting device power state in which it operates from the current lighting device power state to a predetermined lighting device power state. In other words, multiple lighting devices having some or all of the same power profiles stored in memory and optionally also having some or all of the same modules, can be configured to operate in different roles. As an example, a lighting device may be equipped with a communication module and a presence sensor module. A first lighting device may be installed close to a door and a second lighting device may be installed in a room the door leads to. The lighting device near the door can be configured as an ‘entry point role’ and the lighting device in the room can be configured as a ‘follow role’. The lighting device near the door can, due to it being configured as an entry point role, switch between a first lighting device power state in which the communications module is off and the presence sensor module is on to a second lighting device power state in which both the communications module and the presence sensor module are on based on receiving a presence sensor trigger. The lighting device in the room can, due to it being configured as a follow role, switch between a third lighting device power state in which the communications module is on and the presence sensor module is off to the second lighting device power state in which both the communications module and the presence sensor module are on based on receiving a communications module trigger. The sensor near the door can thus save energy by powering down the communications module when there is no presence. When subsequently presence is detected the light can be turned on and a message can be sent using the communications module to the lighting device in the room. The lighting device in the room can thus save energy by powering down the presence sensor module until a message is received from the lighting device near the door. A user passing the door will then cause the lighting device near the door to turn on based on detecting presence and the lighting device in the room based will be turned on due to the lighting device near the door sending a message to the lighting device in the room. Both the presence sensor module of the lighting device near the door and the presence sensor module of the lighting device in the room will then be on, allowing each of the lighting devices to continue to sense presence and keep the light on as long as presence is detected.

FIG. 6 is a system diagram showing an example of control signals being sent between system components in response to trigger events.

The simplified system of FIG. 6 includes a user terminal 602 such as a wall panel or a mobile device running an application or app. The system further includes a controller 604 which may be a lighting controller such as a lighting bridge, or may be a BMS for example, and two lighting devices 606 and 608.

At step 610, a motion sensor on lighting device 606 is activated and causes that device to switch to a profile with a powered light source and to turn the light on. At the same time device 606 sends a signal to device 608 (which may be a neighbouring device in this example) to switch to a different power profile (for example to turn a sensor on). This may correspond to a user entering a room in a similar manner to that described in relation to FIG. 4.

At step 612, a user inputs a lighting control instruction to a user terminal, for example to recall a predetermined lighting configuration for the room, including settings for lighting devices 606 and 608. This sends a signal to the controller 604, which in turn sends signals to devices 606 and 608 in steps 5614 and 5616 respectively. Steps 5612, 5614 and S616 may occur substantially simultaneously. In this example device 606 remains in the same power profile, but the light output is adjusted, while illumination from device 608 is required so this is moved to a higher power profile in which the driver is powered on. As noted control signals to adjust a power profile may be dedicated signals for solely that purpose, or may be lighting control signals for setting an illumination output state, and the corresponding appropriate power profile can be determined based on the lighting control signal. In other words, the system automatically provides illumination for a user entering the room, but that illumination can then be overridden by a user input. The power profiles adopted by the lighting devices involved adapt as the illumination patterns and states change,

At step S618, it is determined at device 608 that a time out condition has occurred, for example that no movement has been detected at device 608 for a set period of time. This results in device 608 switching to a low power profile in which the driver is powered down, and a signal being sent to controller 604, which in turn resets a timer for device 606. At step S620, the timer for device 606 reaches a set period, and the controller sends a signal to device 606 to switch device 606 into a low power profile. This may correspond to a situation in which the user has left the room or space, and the controller, via a set of logic rules, returns the system to a low power state.

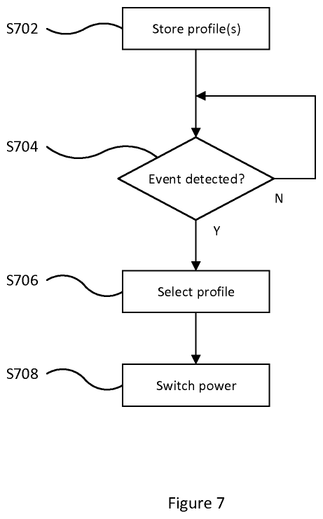

Referring to FIG. 7, there is shown a process of controlling a lighting device, such as the lighting device of FIG. 1, or one or more of the lighting devices in FIGS. 3 to 5 for example. At step S702 power profiles are stored for the or each lighting device in question.

At step S704 it is determined whether an event, which may be one of a list of predetermined events is detected. An event may be detected at the lighting device, such as a sensor output, or may be a signal received from another device or controller. If no event is detected, the device remains in a waiting state.

If an event is detected, the process proceeds to step S706 and a profile from amongst the stored profiles is selected. Possible methods of selecting profiles have been discussed above. Lastly at step S708, based on the selected profile, the appropriate modules of the lighting device are set to the power state as defined by that profile.

The various illustrative logical blocks, functional blocks, modules and circuits described in connection with the present disclosure including the steps of FIG. 7, may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A processor, such as processor 112 or BMS 450 may be implemented as a one or a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A lighting device operable in a plurality of lighting device power states, each of the lighting device power states supporting different functionalities of the lighting device, the lighting device comprising:
at least one light source for providing illumination;
at least a first and second module, said first and second modules being electrically powered, and independently controllable between a power on state and a power off state;
a memory for storing power profile data, each power profile defining one of the plurality of different lighting device power states by defining a module power state for said at least first and second modules and wherein the power profile is reprogrammable for said at least first and second modules;
a controller adapted to control the module power state of said first and second modules to correspond to a power profile stored in said memory thereby controlling the lighting device to operate in one of the plurality of lighting device power states,
wherein the controller is further adapted to change the module power state of the first and/or second module in response to one or more trigger events, thereby changing the lighting device power state in which the lighting device operates.

2. The lighting device according to claim 1, wherein said first module is a communication module adapted to receive control signals for controlling said device.

3. The lighting device according to claim 1, wherein the second module is a sensor.

4. The lighting device according to claim 3, wherein said sensor is one of a motion sensor, light sensor, temperature sensor, humidity sensor, gas sensor, audio sensor or image sensor.

5. The lighting device according to claim 3, wherein a trigger event is an output from one or more sensors of the device.

6. The lighting device according to claim 1, wherein a trigger event is a received control signal.

7. The lighting device according to claim 1, wherein said controller is adapted to select the power profile from among the stored power profiles having the lowest power consumption and which still meets the required functionality of said lighting device.

8. A method of controlling a lighting device to operate in one of a plurality of lighting device power states, each of the lighting device power states supporting different functionalities of the lighting device, the lighting device comprising at least one light source for providing illumination and at least a first and second module, said first and second modules being electrically powered, and independently controllable between a power on state and a power off state, the method comprising:
storing power profile data, each power profile defining one of the plurality of different lighting device power states by defining a module power state for said at least first and second modules and wherein the power profile is reprogrammable for said at least first and second modules;
detecting one or more trigger events;
selecting a power profile from among the stored power profiles in response to the one or more detected trigger events; and
controlling the module power state of said first and second modules to correspond to said selected power profile, thereby controlling the lighting device to operate in one of the plurality of lighting device power states.

9. The method of claim 8, wherein at least one of said first and second modules is a sensor, and a trigger event is an output from one or more sensors of the device.

10. The method of claim 8, wherein at least one of said first and second modules is a communications module, and a trigger event is a received control signal.

11. The method according to claim 10, wherein selecting a power profile and controlling the lighting device power state of the device is performed based on the output of a further device.

12. A method according to claim 9, wherein selecting a power profile includes using rule based logic to combine multiple trigger events.

13. The lighting device according to claim 1, wherein said controller is further adapted to derive an appropriate power profile based on a received control signal and/or on the previous state of the device.

14. The lighting device according to claim 1, wherein the power profile is programmed into the lighting device based on the position of the lighting device and/or the function the lighting device is to perform.

15. The lighting device according to claim 1, wherein the power profile is remotely programmed using the communication module.
